(19) United States
(12) Patent Application Publication
(10) Pub. No.: US 2006/0015875 A1
(43) Pub. Date: Jan. 19, 2006

(54) Distributed processing controller, distributed processing control method, and computer product

(75) Inventors: Yasuhide Ishihara, Kawasaki (JP); Kenji Kawarai, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/233,127

(22) Filed: Sep. 23, 2005

Related U.S. Application Data
(63) Continuation of application No. PCT/JP03/03505, filed on Mar. 24, 2003.

(51) Int. Cl. G06F 9/46

(52) U.S. Cl. 718/102

(57) ABSTRACT

When a distributed processing controller receives a program, which is a job from a terminal unit, a status-confirmation processor transmits a unit processing program and unit data to respective distributed processors A to C registered in a registration table, to select a distributed processor suitable for requesting execution of the program, based on the execution results sent back from the distributed processors A to C.

### BACKGROUND OF THE INVENTION

1. Field of the Invention

The present invention relates to a technology for selecting one of a plurality of distributed processors present on the Internet and request the selected distributed processor to execute a job.

2. Description of the Related Art

Distributed processing techniques that enable balancing of load by use of a plurality of processors distributed on a network have been widely used.

Japanese Patent Application Laid-open No. H7-182217 and No. H11-250020 discloses conventional techniques in which processing is distributed using a plurality of predetermined processors and a controller that controls these distributed processors.

Recently, a distributed processing technique referred to a so-called grid computing has become popular. The grid computing stands for a computing base in which computers (distributed processors) in remote areas are connected via the Internet. In the grid computing, a decision needs to be made as to which distributed processor on the Internet is to be selected to perform the processing.

Because the users will not know which computers are usable, they cannot actualize the computers as distributed processors. Moreover, states of respective computers are always changing, so that even if the information of these computers is centrally controlled, the centrally controlled information may not always be latest. Accordingly, it is difficult for the users to select the most appropriate computer (distributed processor) as a host. As a result, it is an important issue as to how to select the appropriate computer to execute the processing.

### SUMMARY OF THE INVENTION

It is an object of the present invention to at least solve the problems in the conventional technology.

According to one aspect of the present invention, a distributed processing controller that selects any one of a plurality of distributed processors present on the Internet and requests execution of a job to selected distributed processor includes a status-confirming unit that sends a request to at least two of the distributed processors to perform a unit processing, and receives results of the unit processing from the at least two distributed processors; and a selector that selects, to request execution of a job, a distributed processor from among the at least two distributed processors based on received results of the unit processing.

According to another aspect of the present invention, a method of controlling distributed processing including selecting any one of a plurality of distributed processors present on the Internet and requesting execution of a job to selected distributed processor includes sending a request to at least two of the distributed processors to perform a unit processing; receiving results of the unit processing from the at least two distributed processors; and selecting, to request execution of a job, a distributed processor from among the at least two distributed processors based on received results of the unit processing.

According to still another aspect of the present invention, a computer-readable recording medium stores therein a computer program that implements a method according to the present invention on a computer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of a distributed processing system according to an embodiment of the present invention;

FIG. 2 is a flowchart of a processing procedure performed by a terminal unit, a distributed processing controller, and distributed processors shown in FIG. 1;

FIG. 3 is a flowchart of an example of a unit processing program shown in FIG. 1;

FIG. 4 is an explanatory diagram of a case in which the unit processing program shown in FIG. 3 is used; and

FIG. 5 is an example of contents of a registration table shown in FIG. 1.

### DETAILED DESCRIPTION OF THE PREFERRED EMBODIMENTS

Exemplary embodiments of the present invention will be explained in detail with reference to the accompanying drawings. A distributed processing system explained below functions on the Internet.

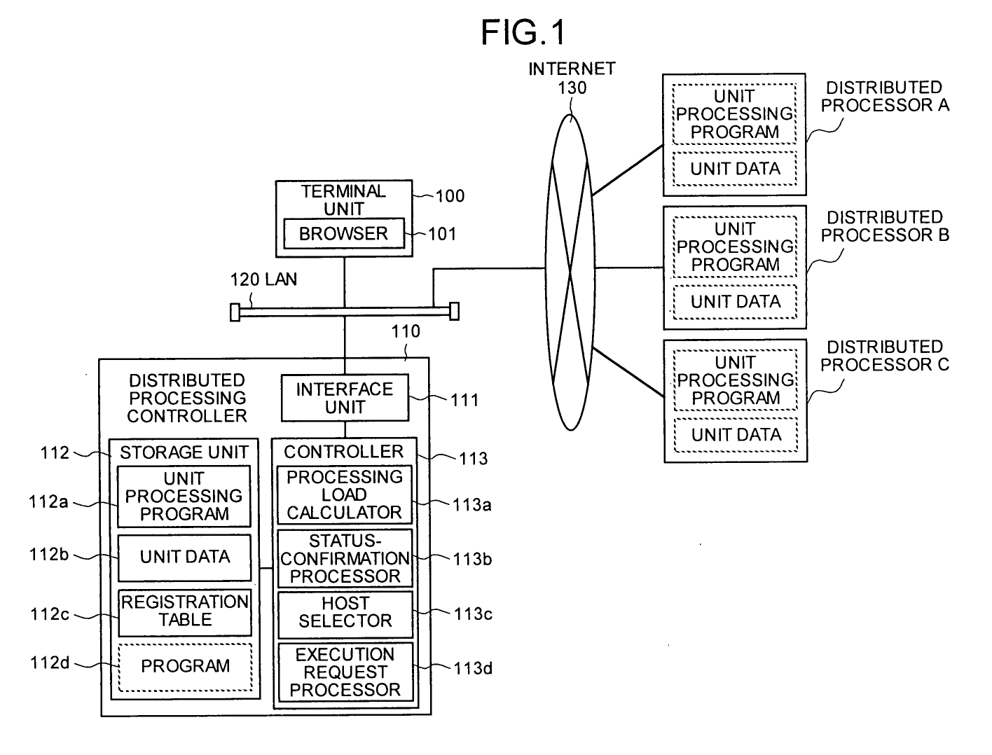

FIG. 1 is a schematic of a distributed processing system according to an embodiment of the present invention. In this distributed processing system, a terminal unit 100 and a distributed processing controller 110 are connected to a LAN 120. The LAN is connected to the Internet 130. Distributed processors A to C are connected to the Internet 130.

That is, the distributed processing system is one form of distributed processing referred to as the grid computing, which is a system in which respective computers connected to the Internet 130 are regarded as the distributed processors, so as to perform the distributed processing.

The terminal unit 100 has a browser 101, and requests execution of a job with respect to the distributed processing controller 110. The terminal unit 100 accesses a website provided by the distributed processing controller 110 using the browser 101 to perform predetermined input on the website, thereby requesting execution of a program 112d as the job. The browser 101 is an application that can browse the website on a World Wide Web (WWW) of the Internet.

The distributed processing controller 110 selects the most appropriate distributed processor from the distributed processors A to C, upon reception of the job execution request from the terminal unit 100, and issues a job execution request with respect to the selected distributed processor. The distributed processing controller 110 selects an appropriate device based on the status of the respective distributed processors A to C, at the time of selecting the distributed processor. This is because even in a distributed processor having high processing capability, the substantial processing capability can be decreased due to the presence of the job under execution.

The distributed processing controller 110 transmits a unit processing program 112a and unit data 112b to the distributed processors A to C. In response, the distributed processors A to C return some information indicative of their current processing capability. The distributed processing controller 110 selects one distributed processor from among the distributed processors A to C based on the returned information.

As shown in FIG. 1, the distributed processing controller 110 includes an interface unit 111, a storage unit 112, and a controller 113. The storage unit 112 stores the unit processing program 112a, the unit data 112b, a registration table 112c, and the program 112d as the job requested from the terminal unit 100. The controller 113 includes a processing load calculator 113a, a status-confirmation processor 113b, a host selector 113c, and an execution request processor 113d.

The interface unit 111 is for transferring data between the distributed processing controller 110 and the terminal unit 100 or the distributed processors A to C via the LAN 120 and the Internet 130, and a network card or the like corresponds thereto. The interface unit 111 performs data transfer processing according to the TCP/IP protocol.

The storage unit 112 is a storage device such as a hard disk or a RAM, and the data is read and written by the respective units in the controller 113. The unit processing program 112a stored in the storage unit 112 is for confirming the processing capability of the respective distributed processors A to C, and includes a program for CPU processing such as a floating-point operation or an integer operation, a program for disk I/O processing such as file input/output, or a program for data transfer such as network transfer.

The unit data 112b is used when executing the unit processing program 112a, and for example, becomes file data of a predetermined data amount (for example, 16 Megabytes) in the case of file input or output, or transfer data of a predetermined amount (for example, 16 Megabytes) in the case of data transfer.

The registration table 112c is a table in which a computer to be used as the distributed processor, of computers on the Internet 130 is registered, and holds IP addresses of the respective distributed processors A to C or the operating environment data. The reason why the registration table 112c is used is that since users can hardly know where the respective distributed processors are located, the distributed processors are actualized by adopting the registration system.

The program 112d is a job that is transmitted from the terminal unit 100. The reason for temporarily storing the program 112d is that it is not transmitted to the respective distributed processors A to C, but the status is confirmed using the unit processing program 112a as the preprocessing.

The controller 113 performs overall control of the distributed processing controller 110. The controller 113 includes a processing function as an HTTP server (not shown), and can browse websites by the browser 101 on the terminal unit 100, and receive an execution request of the job (program 112d) by a predetermined operation.

The processing load calculator 113a calculates the processing load of the job received from the terminal unit 100. Specifically, the processing load calculator 113a calculates the calculation amount, the file input/output amount, and the data transfer amount from the program 112d as the job. For example, the processing load calculator 113a automatically calculates the calculation amount, the file input/output amount, and the data transfer amount from the loop frequency of the program 112d, the count of file input/output command, the count of data transfer command, and the like. The reason why the calculation amount, the file input/output amount, and the data transfer amount are calculated is that the time required for the processing of the job (the program 112d) is estimated from the relation between the calculation amount of the unit processing, program 112a and the time required for the processing of the distributed processors A to C, to determine which distributed processor is to be selected from the estimated value.

The status-confirmation processor 113b transmits the unit processing program 112a and the unit data 112b to the respective distributed processors A to C to request execution, and receives the execution results, to confirm the status of the respective distributed processors A to C through this processing.

The host selector 113c selects the distributed processor (host) that requests the execution of the program 112d as a job using the processing result received from the respective distributed processors A to C by the status-confirmation processor 113b. Specifically, calculation amount J1 of the job (program 112d) calculated by the processing load calculator 113a is divided by calculation amount I1 of the unit processing program 112a, and a value obtained by multiplying this value by computing time (TI1) of the unit processing program 112a is designated as estimated computing time TJ1 of the job (program 112d). That is, TJ1=(J1/I1)×TI1.

Likewise, input/output data amount J2 of the job (program 112d) calculated by the processing load calculator 113a is divided by input/output data amount I2 of the unit processing program 112a, and a value obtained by multiplying this value by input/output time (TI2) of the unit processing program 112a is designated as estimated input/output time TJ2 of the job (program 112d). That is, TJ2=(J2/I2)×TI2.

Furthermore, transferred data amount J3 of the job (program 112d) calculated by the processing load calculator 113a is divided by transferred data amount I3 of the unit processing program 112a, and a value obtained by multiplying this value by data transfer time (TI3) of the unit processing program 112a is designated as estimated data transfer time TJ3 of the job (program 112d). That is, TJ3=(J3/I3)×TI3.

By performing this processing with respect to the respective distributed processors A to C, respectively, to calculate throughput time (=TJ1+TJ2+TJ3) for each of the respective distributed processors A to C, a distributed processor having the shortest throughput time is selected.

The execution request processor 113d requests the execution of the job (program 112d) with respect to the distributed processor selected by the host selector 113c. Specifically, the execution request processor 113d obtains the IP address of the distributed processor selected by referring to the registration table 112c and transmits the job (program 112d) to the distributed processor having the IP address to request the execution thereof.

The distributed processors A to C are computers present in various locations on the Internet 130, and registered in the registration table 112c in the distributed processing controller 110 to function as the distributed processor. Specifically, when the distributed processors A to C receive the program 112d as the job of the terminal unit 100 via the distributed processing controller 110, the distributed processors A to C execute the program 112d and transmit the execution result to the distributed processing controller 110.

The distributed processing controller 110 not only executes the program 112d, but also executes the unit processing program 112a and the unit data 112d received from the distributed processing controller 110 prior to the execution of the program 112d, and returns the unit processing program 112a and the unit data 112d to the distributed processing controller 110. This unit processing program 112a is executed, in order to check the processing capability including the dynamic status of the respective distributed processors A to C at the point in time on the distributed processing controller 110 side, and appropriately select the distributed processor that executes the program 112d as the job.

It is not necessary for the distributed processors A to C to install a program that functions as a mechanism for transferring data between these distributed processors and the distributed processing controller 110, or to store the data therein. That is, as seen from the respective distributed processors A to C, the configuration is not different from the conventional ones in which the program 112d as the job is received from the terminal unit 100, and hence, the configuration according to the present invention is installed only on the distributed processing controller 110 side.

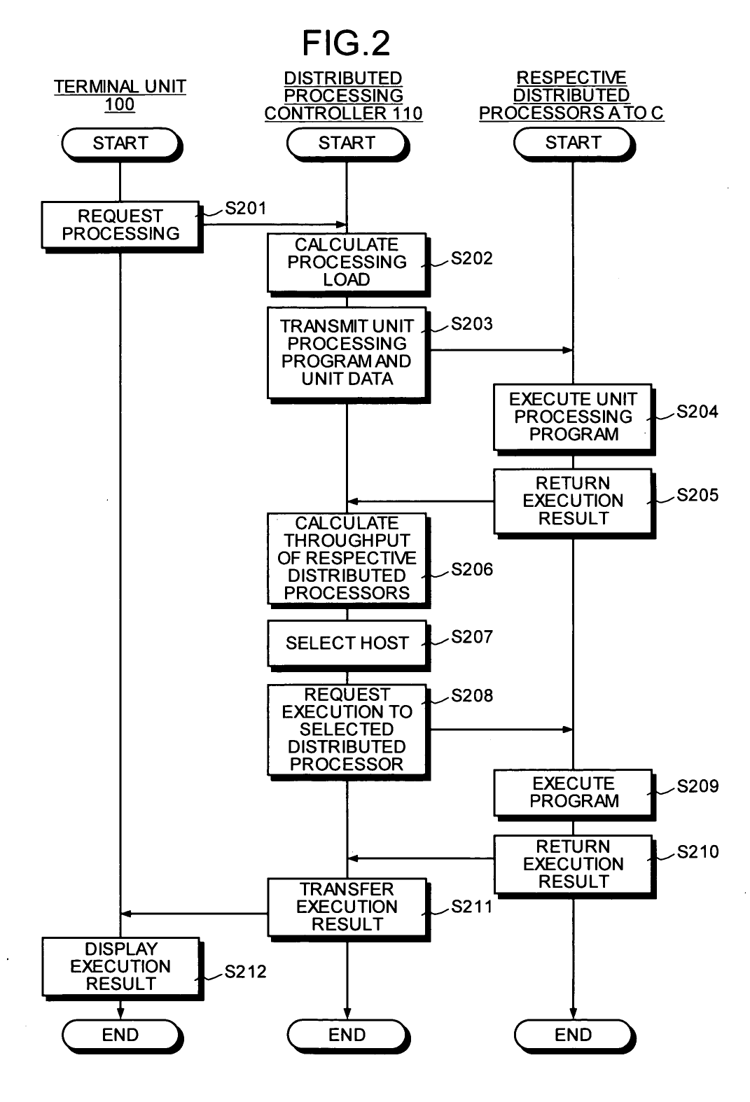

The processing procedure of the terminal unit 100, the distributed processing controller 110, and the respective distributed processors A to C shown in FIG. 1 will be explained below. FIG. 2 is a flowchart of the processing procedure of the terminal unit 100, the distributed processing controller 110, and the respective distributed processors A to C, shown in FIG. 1.

As shown in FIG. 2, when the terminal unit 100 transmits the program 112d as the job to the distributed processing controller 110 to request the processing (step S201), the distributed processing controller 110 temporarily stores the program 112d in the storage unit 112, and the processing load calculator 113a in the distributed processing controller 110 calculates the processing load required for the processing of the program 112d (step S202). Specifically, the calculation amount, the input/output data amount, and the data transfer amount required for the program 112d are estimated from the loop command of the program 112d, the input/output command and the data transfer command. Thereafter, the status-confirmation processor 113b transmits the unit processing program 112a and the unit data 112b to the respective distributed processors A to C.

The respective distributed processors A to C execute the received unit processing program 112a using the unit data 112b (step S203), and send back the execution result to the distributed processing controller 110 (step S204).

When having received the execution result from the respective distributed processors A to C, the distributed processing controller 110 calculates the throughput of the respective distributed processors A to C (step S206). Specifically, the calculation amount J1 of the program 112d is divided by the calculation amount I1 of the unit processing program 112a, and a value obtained by multiplying this value by the computing time (TI1) of the unit processing program 112a is designated as estimated computing time TJ1 of the job (program 112d). The input/output data amount J2 of the program 112d is divided by the input/output data amount I2 of the unit processing program 112a, and a value obtained by multiplying this value by the input/output time (TI2) of the unit processing program 112a is designated as estimated input/output time TJ2 of the job (program 112d). Furthermore, the transferred data amount J3 of the program 112d is divided by the transferred data amount I3 of the unit processing program 112a, and a value obtained by multiplying this value by the data transfer time (TI3) of the unit processing program 112a is designated as estimated data transfer time TJ3 of the job (program 112d), to calculate the throughput time (=TJ1+TJ2+TJ3).

Thereafter, the host selector 113c selects the distributed processor having the smallest throughput, of the throughput of the respective distributed processors A to C, as an execution request destination of the program 112d (step S207). The execution request processor 113d transmits the program 112d to the distributed processor selected by the host selector 113c.

Upon reception of the program 112d, the distributed processor executes the program 112d (step S209), and sends back the execution result to the distributed processing controller 110 (Step S210). The distributed processing controller 110 further transfers the execution result to the terminal unit 100 (step S211), and the execution result is finally displayed on a display screen of the terminal unit 100 (step S212).

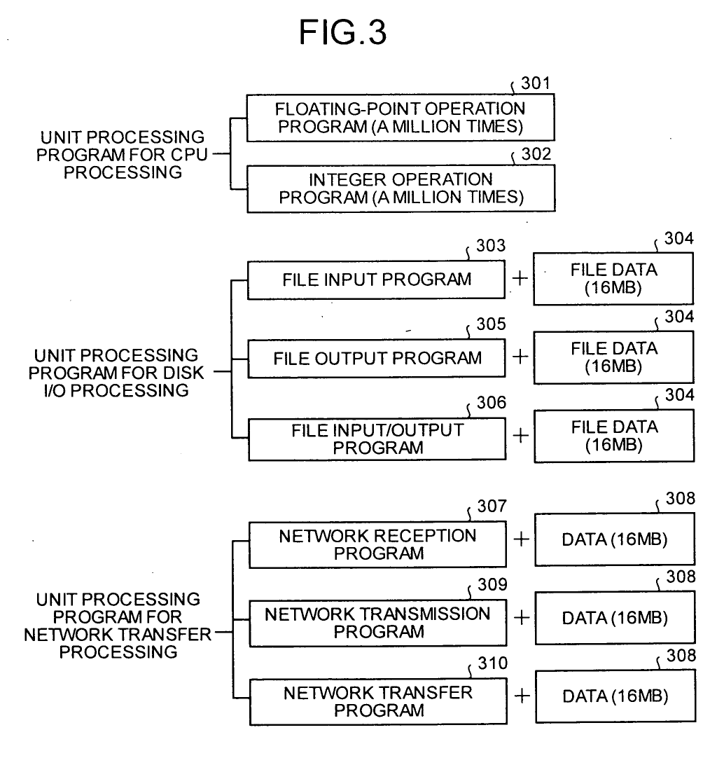

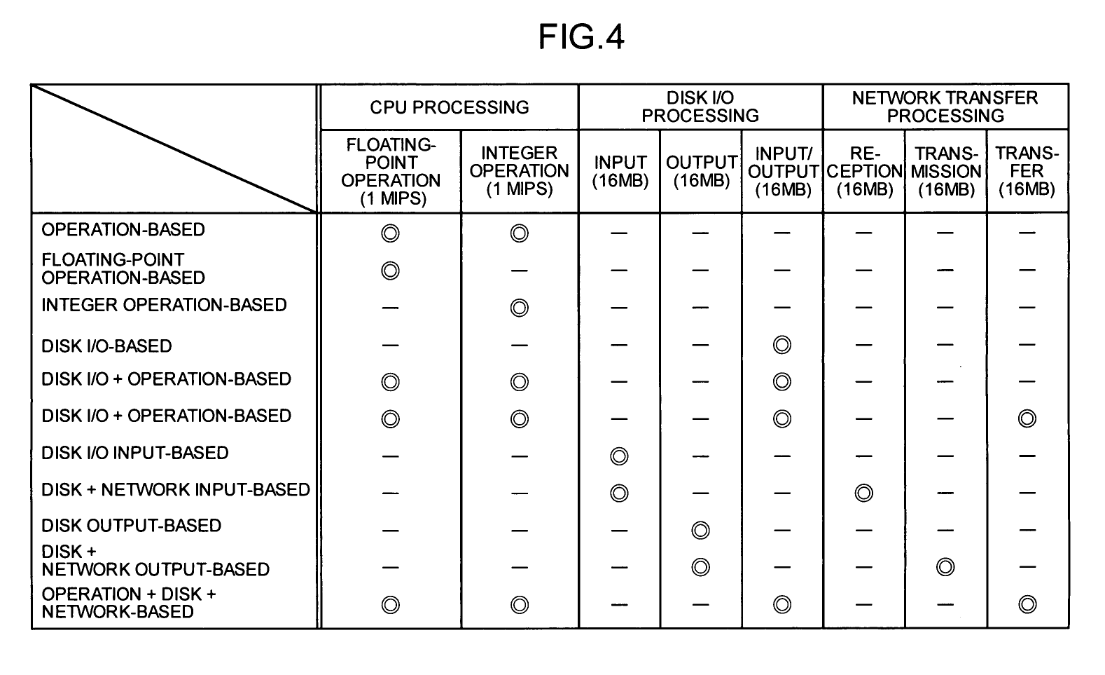

One example of the unit processing program 112a and the unit data 112b shown in FIG. 1 will be explained. FIG. 3 is an example of the unit processing program 112a and the unit data 112b shown in FIG. 1, and FIG. 4 is an explanatory diagram of a case that the unit processing program 112a shown in FIG. 3 is used.

As shown in FIG. 3, the unit processing program 112a includes a unit processing program for CPU processing for checking the processing time of the CPU, a unit processing program for disk I/O processing for checking the processing time of disk I/O, and a unit processing program for network transfer processing for checking the processing time of data transfer on the network.

A floating point operation program 301 of 1 MIPS or an integer operation program 302 of 1 MIPS can be used as the unit processing program for CPU processing.

A file input program 303, a file output program 305, and a file input/output program 306 can be used as the unit processing program for disk I/O processing. File data (for example, 16 Megabytes) 304 used at the time of executing these programs is provided as the unit data 112b from the distributed processing controller 110 side to the respective distributed processors A to C.

A network reception program 307, a network transmission program 309, and a network transfer program 310 can be used as the unit processing program for network transfer processing. Data (for example, 16 Megabytes) 308 used at the time of executing these programs is provided as the unit data 112b from the distributed processing controller 110 side to the respective distributed processors A to C. The data transfer destination on the network can be optionally set, but the distributed processing controller 110 can be set as the data transfer destination.

How to use the unit processing program 112a corresponding to respective statuses will be explained. As shown in FIG. 4, when the program 112d as the job is operation-based, it is desired to use the floating point operation program (1 MIPS: million instructions per second) 301 and the integer operation program (1 MIPS) 302.

When the program 112d as the job is floating point operation-based, it is desired to use the floating-point operation program (1 MIPS) 301, and when the program 112d is integer operation-based, it is desired to use the integer operation program (1 MIPS) 302.

When the program 112d as the job is disk I/O-based, it is desired to use the file input/output program 306, and when the program 112d is disk I/O and operation-based, it is desired to use the floating point operation program (1 MIPS) 301, the integer operation program (1 MIPS) 302, and the file input/output program 306. When the network transfer is taken into consideration, it is desired to use the network transfer program 310.

When the program 112d as the job is disk I/O input-based, it is desired to use the file input program 303, and when the program 112d is disk input and network input-based, it is desired to use the file input program 303 and the network reception program 307.

When the program 112d as the job is disk I/O output-based, it is desired to use the file output program 305, and when the program 112d is disk I/O output and network output-based, it is desired to use the file output program 305 and the network transfer program 309.

When the program 112d as the job is all of operation, disk I/O, and network transfer-based, it is desired to use the floating point operation program (1 MIPS) 301, the integer operation program (1 MIPS) 302, the file input/output program 306, and the network transfer program 310.

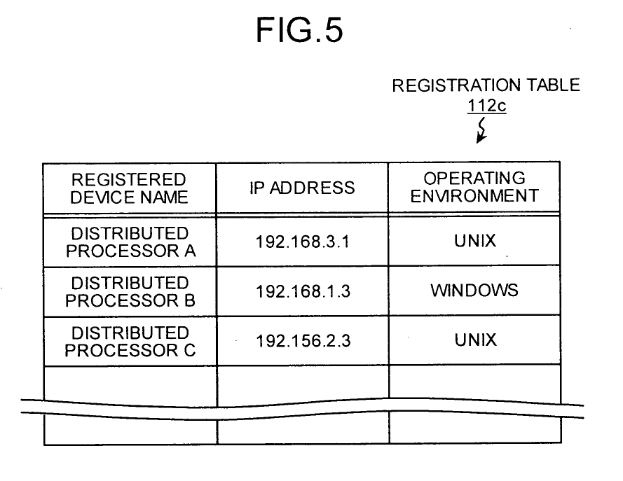

An example of the registration table 112c shown in FIG. 1 will be explained. FIG. 5 is an example of the registration table 112c shown in FIG. 1. As shown in FIG. 5, only computers that function as the distributed processor, of the various kinds of computers on the Internet, are registered in the registration table 112c. The reason why such registration is performed is that in the grid computing system, it is not actualized-for the users who use the terminal units 100 as to which computer can be used as the distributed processor, and a lot of time is required for selection of the distributed processor.

As shown in FIG. 5, the registered device name indicating the computer name, the IP address of the computer, and the operating environment of the computer are stored in association with each other in the registration table 112c. For example, for the distributed processor A, the IP address 192.168.3.1 and UNIX as the operating system thereof are stored in association with each other.

For the distributed processor B, the IP address 192.168.1.3 and WINDOWS as operating system thereof are stored, and for the distributed processor C, the IP address 192.156.2.3 and UNIX as the operating system thereof are stored, in association with each other.

When the operating environment of the distributed processors A to C is different, it is necessary to prepare the unit processing program 112a for each operating environment and hold it in the distributed processing controller 110, and transmit the unit processing program 112a suitable for the operating environment to the distributed processors A to C.

As explained above, in the embodiment, when the distributed processing controller 110 receives the program 112d, which is the job from the terminal unit 100, the status-confirmation processor 113b transmits the unit processing program 112a and the unit data 112b to the respective distributed processors A to C registered in the registration table 112c, to select a distributed processor suitable for requesting execution of the program 112d, based on the execution results returned from the distributed processors A to C. Accordingly, the distributed processor suitable for requesting the processing is selected to request the execution of processing, thereby enabling efficient load balancing.

While a case that the present invention is applied to a client-server system has been explained here, the invention is also applicable to a case where an autonomous agent such as a telescript is used. Specifically, the distributed processing controller 110 prepares an autonomous agent having the unit processing program 112a, the unit data 112b, and the registration table 112c therein, and sends out the autonomous agent, upon reception of the program 112d as the job from the terminal unit 100. The autonomous agent accesses computers that function as distributed processors by themselves, to obtain the execution result of the unit processing program 112a, and after having obtained all execution results, returns to the distributed processing controller 110. Accordingly, a distributed processor suitable for requesting the execution of the program 112d as the job can be efficiently selected, by the execution results obtained by the autonomous agent.

While an example of the unit processing program 112a has been explained with reference to FIGS. 3 and 4, the invention is not limited thereto and also applicable to a case that other unit processing programs are used.

According to the present invention, efficient load balancing can be performed because an appropriate distributed processor can be selected. Moreover, users can actualize a computer from among the computers present in various locations on the Internet. Furthermore, it is not necessary to install the unit processing program and the like in the respective distributed processors, and the appropriate distributed processor can be selected smoothly, without requiring preparation with respect to the distributed processors.

According to the present invention, a distributed processor suitable for any one of the calculation amount, the input/output amount, and the data transfer amount of the job can be selected. Moreover, a distributed processor suitable for the calculation amount of the job can be efficiently selected with a simple operation. Furthermore, a distributed processor suitable for the input/output amount of the job can be efficiently selected with a simple operation. Moreover, a distributed processor suitable for the data transfer amount of the job can be efficiently selected with a simple operation.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A distributed processing controller that selects any one of a plurality of distributed processors present on the Internet and requests execution of a job to selected distributed processor, comprising:
a status-confirming unit that sends a request to at least two of the distributed processors to perform a unit processing, and receives results of the unit processing from the at least two distributed processors; and
a selector that selects, to request execution of a job, a distributed processor from among the at least two distributed processors based on received results of the unit processing.

2. The distributed processing controller according to claim 1, further comprising a registering unit that registers therein the at least two distributed processor from among the distributed processors present on the Internet.

3. The distributed processing controller according to claim 1, further comprising a storage unit that stores therein a first computer code for executing the unit processing, and unit data used at the time of executing the computer code, wherein
the status-confirming unit transmits the first computer code and the unit data to the at least two distributed processors.

4. The distributed processing controller according to claim 3, wherein the storage unit stores therein a first number that is number of calculation required to be performed for the processing the job, a second computer code for performing processing respectively corresponding to a part of any one of the file input/output processing and the data transfer processing or both for the job, and unit data used at the time of executing the second computer code, wherein
the selector selects a distributed processor based on
unit processing time required to receive the results of the unit processing from the at least two distributed processors,
a second number that is number of calculations required to be performed to execute the first computer code, input/output processing amount required when executing the first computer code, and data transfer amount required when executing the first computer code, and
the first number, input/output processing amount required when executing the job, and data transfer amount required when executing the job.

5. The distributed processing controller according to claim 4, wherein the selector designates a value obtained by dividing the first number by the second number and multiplying the value by the unit processing time as estimated computing time, and selects a distributed processor based on the estimated computing time.

6. The distributed processing controller according to claim 4, wherein the selector designates a value obtained by dividing the input/output processing amount required when executing the job by the input/output processing amount required when executing the first computer code and multiplying the value by the unit processing time as estimated input/output processing time, and selects a distributed processor based on the estimated input/output processing time.

7. The distributed processing controller according to claim 4, wherein the selector designates a value obtained by dividing the data transfer amount required when executing the job by the data transfer amount required when executing the first computer code and multiplying the value by the unit processing time as estimated data transfer time, and selects a distributed processor based on the estimated data transfer time.

8. A method of controlling distributed processing including selecting any one of a plurality of distributed processors present on the Internet and requesting execution of a job to selected distributed processor, comprising:
sending a request to at least two of the distributed processors to perform a unit processing;
receiving results of the unit processing from the at least two distributed processors; and
selecting, to request execution of a job, a distributed processor from among the at least two distributed processors based on received results of the unit processing.

9. The method according to claim 8, further comprising deciding the at least two distributed processor from among the distributed processors present on the Internet.

10. The method according to claim 8, further comprising storing a first computer code for executing the unit processing, and unit data used at the time of executing the computer code, wherein
the sending includes transmitting the first computer code and the unit data to the at least two distributed processors.

11. The method according to claim 10, wherein the storing includes storing a first number that is number of calculation required to be performed for the processing the job, a second computer code for performing processing respectively corresponding to a part of any one of the file input/output processing and the data transfer processing or both for the job, and unit data used at the time of executing the second computer code, wherein
the selecting includes selecting a distributed processor based on
unit processing time required to receive the results of the unit processing from the at least two distributed processors,
a second number that is number of calculations required to be performed to execute the first computer code, input/output processing amount required when executing the first computer code, and data transfer amount required when executing the first computer code, and
the first number, input/output processing amount required when executing the job, and data transfer amount required when executing the job.

12. The method according to claim 11, wherein the selecting includes selecting a distributed processor based on an estimated computing time defined by a value obtained by dividing the calculation amount of the job by a value obtained by dividing the first number by the second number and multiplying the value by the unit processing time.

13. The method according to claim 11, wherein the selecting includes selecting a distributed processor based on an estimated input/output processing time defined by a value obtained by dividing the input/output processing amount required when executing the job by the input/output processing amount required when executing the first computer code and multiplying the value by the unit processing time.

14. The method according to claim 11, wherein the selecting includes selecting a distributed processor based on an estimated data transfer time defined by a value obtained by dividing the data transfer amount required when executing the job by the data transfer amount required when executing the first computer code and multiplying the value by the unit processing time.

15. A computer-readable recording medium that stores therein a computer program for controlling distributed processing selecting any one of a plurality of distributed processors present on the Internet and requesting execution of a job to selected distributed processor, the computer program causing a computer to execute:
sending a request to at least two of the distributed processors to perform a unit processing;
receiving results of the unit processing from the at least two distributed processors; and
selecting, to request execution of a job, a distributed processor from among the at least two distributed processors based on received results of the unit processing.

16. The computer-readable recording medium according to claim 15, wherein the computer program further causes the computer to execute deciding the at least two distributed processor from among the distributed processors present on the Internet.

17. The computer-readable recording medium according to claim 15, wherein the computer program further causes the computer to execute storing a first computer code for executing the unit processing, and unit data used at the time of executing the computer code, wherein
the sending includes transmitting the first computer code and the unit data to the at least two distributed processors.

18. The computer-readable recording medium according to claim 17, wherein the storing includes storing a first number that is number of calculation required to be performed for the processing the job, a second computer code for performing processing respectively corresponding to a part of any one of the file input/output processing and the data transfer processing or both for the job, and unit data used at the time of executing the second computer code, wherein
the selecting includes selecting a distributed processor based on
unit processing time required to receive the results of the unit processing from the at least two distributed processors,
a second number that is number of calculations required to be performed to execute the first computer code, input/output processing amount required when executing the first computer code, and data transfer amount required when executing the first computer code, and
the first number, input/output processing amount required when executing the job, and data transfer amount required when executing the job.

19. The computer-readable recording medium according to claim 18, wherein the selecting includes selecting a distributed processor based on an estimated computing time defined by a value obtained by dividing the calculation amount of the job by a value obtained by dividing the first number by the second number and multiplying the value by the unit processing time.

20. The computer-readable recording medium according to claim 18, wherein the selecting includes selecting a distributed processor based on an estimated input/output processing time defined by a value obtained by dividing the input/output processing amount required when executing the job by the input/output processing amount required when executing the first computer code and multiplying the value by the unit processing time.

21. The computer-readable recording medium according to claim 18, wherein the selecting includes selecting a distributed processor based on an estimated data transfer time defined by a value obtained by dividing the data transfer amount required when executing the job by the data transfer amount required when executing the first computer code and multiplying the value by the unit processing time.
